(19) United States
(12) Patent Application Publication
(10) Pub. No.: US 2011/0048019 A1
(43) Pub. Date: Mar. 3, 2011

(54) TURBINE ENHANCEMENT SYSTEM

(76) Inventors: David Smyth, County Longford (IE); James Smyth, County Cavan (IE); Peter Smyth, County Longford (IE); Gerard Smyth, County Longford (IE); Andrew Smyth, County Armagh (GB)

(21) Appl. No.: 12/918,622

(22) PCT Filed: Feb. 23, 2009
(86) PCT No.: PCT/EP2009/001275

§ 371 Date: Nov. 11, 2010

(30) Foreign Application Priority Data
Feb. 22, 2008 (IE) 2008/0134
Mar. 13, 2008 (IE) S2008/0192

(51) Int. Cl. F02C 7/00

(52) U.S. Cl. 60/722

(57) ABSTRACT

The present invention is concerned with a system and method for enhancing the performance of a wind turbine, which involves injecting air from an array of nozzles into the airflow upstream of the turbine in order to reduce the turbulence and/or increase the velocity and/or control the pressure of the airflow, thereby improving the performance of the turbine.

### FIELD OF THE INVENTION

This invention relates to a turbine enhancement system and a method for enhancing or improving the power output and/or efficiency of a wind turbine, and in particular to a system and method which are designed to condition the wind flowing past a turbine in order to reduce the turbulence and/or increase the pressure and/or velocity of the wind.

### BACKGROUND OF THE INVENTION

In today's environment of global warming and environmental awareness, renewable energy is becoming more and more important, with wind turbines, both on and off shore, being the most well-established form of renewable energy. While wind turbines have proven a viable option for generating electricity or other forms of energy, they do have their limitations. One of the main issues with wind turbines is a phenomenon known as the “Betz limit” which determines the maximum limit of a wind turbine's performance. This results from a pressure drop across the rotor of the turbine in which the air directly behind the blades is at sub-atmospheric pressure and the air directly in front of the blades is at greater than atmospheric pressure. This elevated pressure in front of the turbine deflects some of the wind or upstream air around the turbine, thus putting a limit on the amount of work which can be extracted by the turbine.

However, this Betz limit is rarely reached in most commercial wind turbines, due to fluctuating wind velocities, which is another drawback when using wind turbines. Wind velocity cannot be guaranteed, and therefore the power generated by wind turbines is inconsistent, and this obviously creates issues when supplying electricity for consumption. As a result it is normally necessary to carefully select the site at which wind turbines are located, choosing sites in areas having higher prevailing wind velocities, and also generally choosing sites of moderate elevation. It is also preferable to have the blades of the turbine located at a certain height off the ground, as wind velocity is generally higher at altitude as a result of the drag experienced at ground level and the lower viscosity of the air at height. Regardless of the height however, in airflow over solid bodies such as turbine blades, turbulence is responsible for increased drag and heat transfer. Thus in such applications, and in this case wind turbines, the greater the turbulence of the air or “wind” flowing over the blades, the less efficient the transfer of energy from the wind to the turbine blades.

German patent application DE4323132 discloses a jet type wind turbine (JWT) which uses the dynamic (total, Pitot, ram, stagnation) pressure of the wind by means of annular (ring) nozzles, which are arranged in a circular plane upstream of the rotor, in order to accelerate the incident wind and direct it at a constant angle onto the rotor blades by passing the incident wind itself though the array of nozzles.

UK patent application GB2297358 discloses a turbine system for the generation of electricity from the ram effect of air or water flowing into the system. The ram effect forces air into an inlet scoop 2 and casing 3. The air then flows into opposed sectorial openings of a gate unit 9 and into a fixed guide vane unit 7 which guides the air smoothly into the vane passages of the turbine wheel 6 which rotates along with gate unit 9 since they are keyed to the shaft 8. Power is generated in a coupled generator 5 which can charge batteries or drive a motor.

UK patent application GB 2230565 discloses an axial flow wind turbine comprises a casing (a), stator blades (c), rotor blades (d) and electric generator casing (e). An annular disc portion (g) generates a low pressure downstream of the device as a result of air flowing outside the casing.

It is an object of the present invention to provide an alternative system and method for improving the efficiency of a wind turbine, which is relatively simple to produce and operate, and which is preferably adapted to be fitted to new wind turbines but also to be retrofittable to existing wind turbines.

### SUMMARY OF THE INVENTION

According to a first aspect of the present invention there is provided a turbine enhancement system comprising an injector for injecting a first fluid into an upstream second fluid flow of a turbine in a manner which conditions the second fluid flowing past blades of the turbine.

Preferably, the injector is adapted to issue at least one jet of the first fluid therefrom.

Preferably, the enhancement system comprises means for supplying the first fluid to the injector.

Preferably, the supply means are arranged to supply the first fluid to the injector from a location remote from the upstream second fluid flow of the turbine.

Preferably, the injector comprises an inlet with which the supply means is in fluid communication, and an outlet from which the first fluid is injected into the upstream second fluid flow.

Preferably, the injector is shaped and dimensioned to accelerate the first fluid flowing therethrough.

Preferably, the injector is adapted to provide a designed velocity profile across a targeted sweep area of the blades of the turbine.

Preferably, the injector comprises at least one array of nozzles.

Preferably, the injector comprises a first array of nozzles locatable a first distance from the turbine, and a second array of nozzles locatable a second distance from the turbine.

Preferably, the injector is adapted to condition the second fluid flow over a targeted sweep area of the blades.

Preferably, at least some of the nozzles comprise air induction nozzles.

Preferably, the supply means comprises a fan and motor.

Preferably, the supply means comprises ducting extending from the fan to the injector.

Preferably, the ducting comprises a support for the injector.

Preferably, the enhancement system comprises a coupling adapted to enable the injector to be mounted to a turbine.

Preferably, the coupling is adapted to enable the injector to undergo displacement relative to the turbine in a manner which allows the injector to track a set of blades of the turbine.

Preferably, the supply means are adapted to be powered by the turbine.

Preferably, the enhancement system comprises a wind turbine with which the injector is in operative association.

Preferably, the enhancement system comprises a first guide which is shaped and dimensioned to funnel the upstream second fluid flow towards the turbine, the injector being arranged to inject the first fluid into the upstream second fluid flow within the first guide.

Preferably, the enhancement system comprises a second guide which cooperates with the first guide to focus the upstream second fluid flow onto a selected portion of the sweep area of the blades of the turbine.

Preferably, the injector comprising an array of nozzles disposed about the first and/or second guide.

Preferably, the dimensions of the first and/or second guide may be varied.

Preferably, the first guide comprises a truncated conical cowl.

Preferably, the second guide comprises a cone mounted concentrically within the cowl such as to define a substantially annular channel between the cowl and the cone

Preferably, the enhancement system comprises means for re-circulating at least a portion of the second fluid exiting a downstream side of the blades back to the upstream side of the blades.

Preferably, the supply means utilise mechanical induction to supply the first fluid to the injector.

According to a second aspect of the present invention there is provided a method for enhancing the performance of a turbine, the method comprising injecting a first fluid into an upstream second fluid flow of the turbine in a manner which conditions the second fluid flowing past blades of the turbine.

Preferably, the method comprises the step of issuing at least one jet of the first fluid into the upstream second fluid flow.

Preferably, the method comprises the step of supplying the first fluid for injection from a location remote from the upstream second fluid flow of the turbine.

Preferably, the method comprises the step of accelerating the first fluid flowing during injection into the upstream airflow.

Preferably, the method comprises the step of injecting the first fluid into the upstream second fluid flow from a first location.

Preferably, the method comprises the step of injecting the first fluid into the second fluid flow from a second location remote from the first location.

Preferably, the method comprises the step extracting power from the turbine in order to affect the supply of the first fluid for injection.

As used herein, the term “injecting” is intended to mean the introduction of an additional supply of fluid such as air into an existing airflow in order to modify the airflow, as opposed to simply passing the entire airflow through a nozzle or cowl to modify the direction/velocity/pressure of the airflow.

As used herein, the term “upstream airflow” or “airflow” is intended to mean the flow of air, generally but not exclusively in the form of wind, which moves past a wind turbine and from which the turbine extracts energy through the rotation of the blades of the turbine in response to the passage of the wind.

As used herein, the term “conditions” is intended to mean reducing the turbulence, and/or increasing the velocity, and/or adjusting or controlling the pressure of fluid flow, in particular wind, flowing towards and past a turbine.

### BRIEF DESCRIPTION OF THE DRAWINGS

FIG. 1 illustrates a perspective schematic illustration of part of a 1^{st} embodiment of a turbine enhancement system according to the present invention;

FIG. 2 illustrates a plan view of the system illustrated in FIG. 1;

FIG. 3 illustrates a further perspective view of the entire 1^{st} embodiment of the turbine enhancement system according to the present invention;

FIG. 4 illustrates the area over which the enhancement system is effective, superimposed on a view of the sweep area of the blades of a wind turbine;

FIG. 5 illustrates a front perspective view of a second embodiment of a turbine enhancement system according to the present invention, mounted in front of a three blade wind turbine;

FIG. 6 illustrates a rear view of the enhancement system illustrated in FIG. 5;

FIG. 7 illustrates a side view of the enhancement system illustrated in FIGS. 5 and 6; and

FIG. 8 illustrates a sectioned plan view of the enhancement system illustrated in FIGS. 5 to 7 with an additional component provided thereon to further improve the performance of a wind turbine.

### DETAILED DESCRIPTION OF THE DRAWINGS

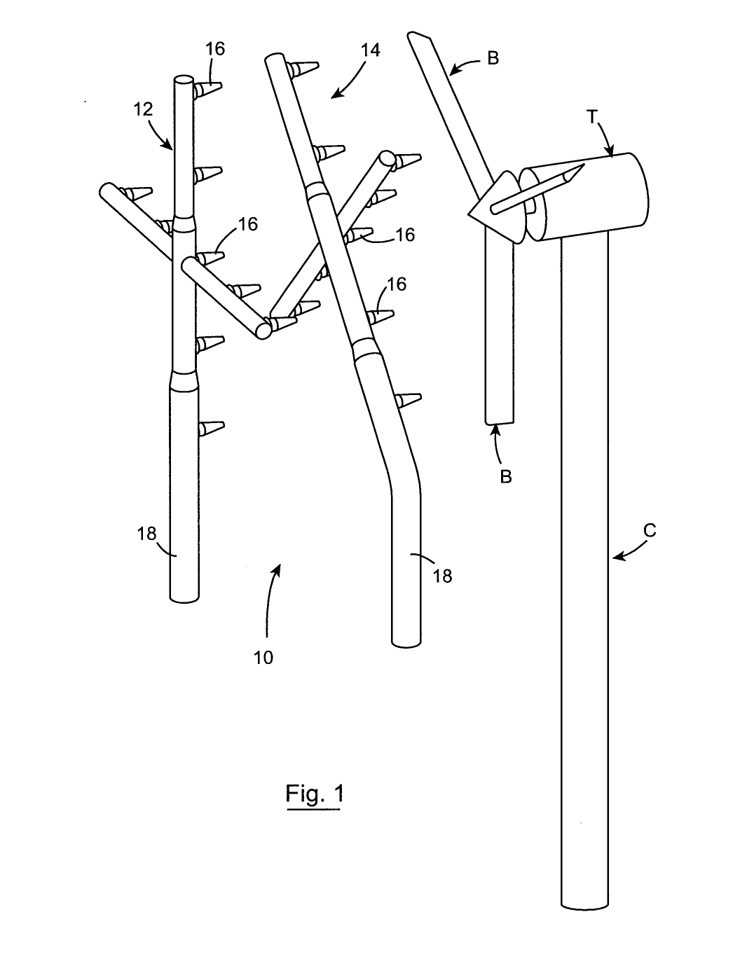

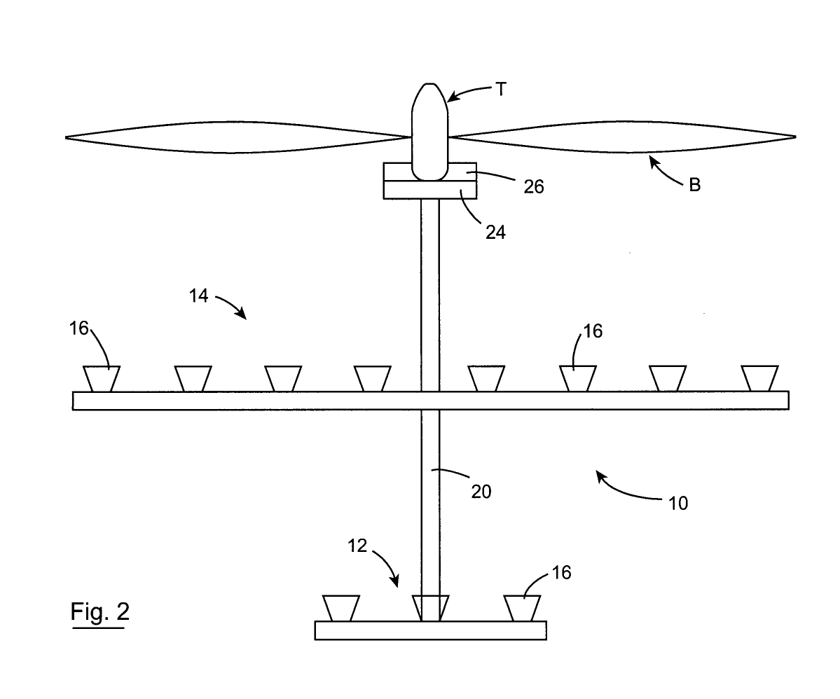

Referring now to FIGS. 1 to 4 of the accompanying drawings, there is illustrated a first embodiment of a turbine enhancement system, generally indicated as 10, which is adapted to be retrofitted to, or formed integrally with, a turbine such as a wind turbine T. The enhancement system 10 may also be designed as a stand alone unit to be positioned upstream of an existing wind turbine (not shown), as opposed to being directly mounted to the turbine. The enhancement system 10 of the present invention is operable according to the method of the present invention, and as described hereinafter, to enhance the performance or power output of the turbine T.

For conventional wind turbines, the power generated by the wind is highly dependent upon the wind's velocity and is determined by the following equation;

Power=½(p×A×V³)

### Where

p is the density of air

A is the area of the blades

V is the Wind Velocity

A wind turbine has the potential to extract a portion of this power, which as mentioned above, is limited by the Betz law to 59%. It can also be seen from the above power equation that the power generated varies with the cube of the wind's velocity, and thus a slight increase in average wind velocity can have a significant increase in power generated by a turbine. The enhancement system 10 of the present invention is designed to maintain the wind velocity past the turbine T at elevated velocities, depending on the prevailing wind conditions, and thereby significantly increase the power generated by the Turbine T, for a relatively small energy input required to operate the system 10.

The system 10 comprises an injector in the form of a first array 12 and a second array 14 of nozzles 16, which are positioned in use, upstream of blades B of the turbine T. The nozzles 16 are adapted, as will be described in detail hereinafter, to issue high velocity jets of a first fluid, for example air, towards the blades B, at a velocity and in a direction which conditions the airflow by both reducing the turbulence, controlling the pressure and increasing the velocity of a second fluid, for example air in the form of wind, blowing past the blades B. It will therefore be appreciated, in particular from the following description of the operation of the enhancement system 10, that a single array of the nozzles 16 could be employed in order to achieve the above mentioned functionality. In addition the number and design of nozzles 16 may be varied as required, in particular to suit the diameter of the blades B. Indeed, the nozzles 16 could be replaced with any other means capable of injecting air into the wind upstream of the turbine T. The nozzles 16 could also inject a fluid or gas other than air, although this is less desirable.

Each of the arrays 12, 14 is supported on respective ducting 18 which forms a part of supply means adapted to feed air to the nozzles 16 during use. It will however be appreciated that the arrays 12, 14 of nozzles 16 could be provided with any other suitable support structure adapted to hold the nozzles 16 in the correct position and orientation relative to the blades B of the turbine T. Such a support structure need not double as the ducting to supply air to the nozzles 16, which may be provided as a separate component.

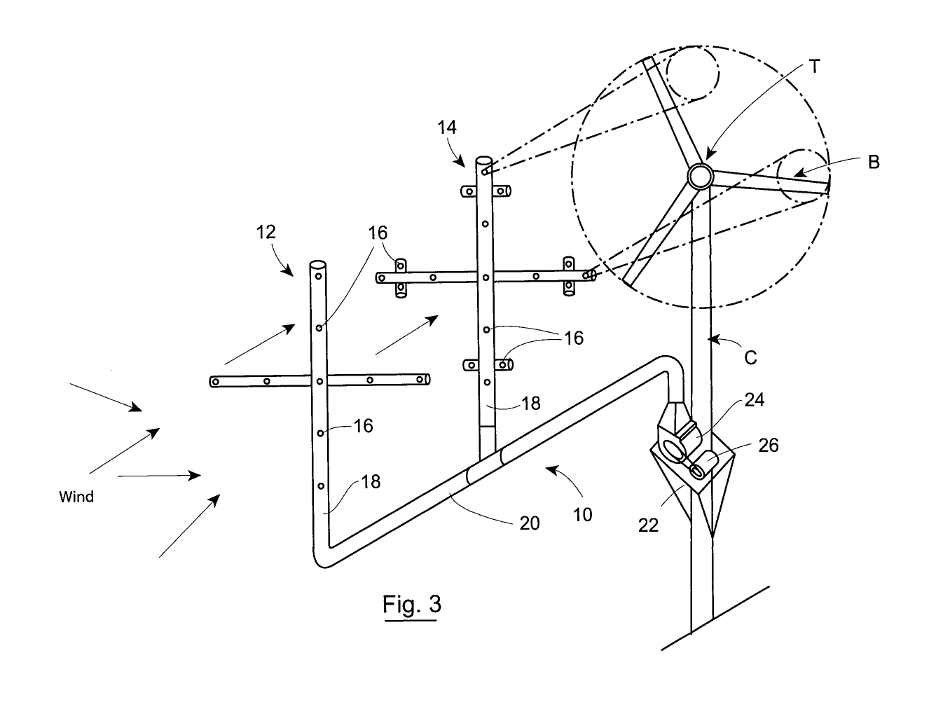

Referring to FIG. 3 it can be seen that in the embodiment illustrated the two branches of ducting 18 connect into a common boom 20 which is itself pivotally mounted to a column C or other support structure (not shown) of the turbine T via a coupling 22. The coupling 22 includes a support (not shown) that carries a fan 24 and a motor 26 which drives the fan 24, both of which thus form part of the supply means adapted to feed air to the nozzles 16. The fan 24 and motor 26 could of course be replaced with any other means capable of supplying air to the nozzles 16. The fan 24 supplies pressurised air into the boom 20 and ducting 18 in order to supply pressurised air to the nozzles 16. The nozzles 16 thus comprise an inlet to which the ducting 18 is connected, and an outlet directed towards the turbine T from which a jet of air issues into the upstream airflow. The upstream airflow does not therefore pass through the nozzles 16, which are closed to the upstream airflow.

The fan 24 is preferably located in a position remote from the upstream airflow and thus supplies air to the nozzles 16 from said remote position. In this way the air injected into the upstream airflow is an additional source of air used to condition the upstream airflow, as opposed to conditioning by passing the upstream airflow itself by passing it through a nozzle or cowl or the like, as is known in the art.

In the preferred embodiment illustrated, the motor 26 is powered from energy, preferably in the form of electricity, generated by the turbine T. It will however be appreciated that an external source of power could be used for the motor 26. The coupling 22 allows the arrays 12, 14 to rotate such as to track the blades B of the turbine T when following the wind. Any suitable means of both tracking the direction of the prevailing wind and affecting a corresponding displacement of the coupling 22 on the column C may be employed. The coupling 22 could therefore be omitted for a fixed head wind turbine.

It is also envisaged that the enhancement system 10 could be provided as a stand alone unit mounted independently of the turbine T, and in such a situation means could be provided in order to allow the arrays 12, 14 to track the turbine T as it rotates to point into the prevailing wind. For example, a wind vein and associated controls could be used to ensure that the system 10 and turbine T rotate together to maximise the effect of the prevailing wind.

In use, once the turbine T is generating power, the motor 26 is turned on in order to power the fan 24, which may be of any suitable design. The fan 24 therefore pumps pressurised air into the boom 20 and ducting 18, which is therefore supplied to both the first and second arrays 12, 14 of nozzles 16. In the preferred embodiment illustrated the nozzles 16 are of the induction type, and thus issue jets of accelerated air towards the sweep area, or a targeted portion of the sweep area, of the blades B. The initially turbulent wind flows past the first array 12 and the jets of air issuing from the respective nozzles 16 condition the air by reducing the turbulence of the wind, while also increasing the velocity of the wind and directing it towards the second array 14. It is envisaged that in order to maximise this redirection, the direction in which the individual nozzles 16 point may be varied to suit the prevailing wind conditions. It should also be understood that the number and arrangement of the nozzles in both the first and second arrays 12, 14 may be significantly varied and indeed may be required to be varied to suit local conditions and/or the size/design of the turbine T.

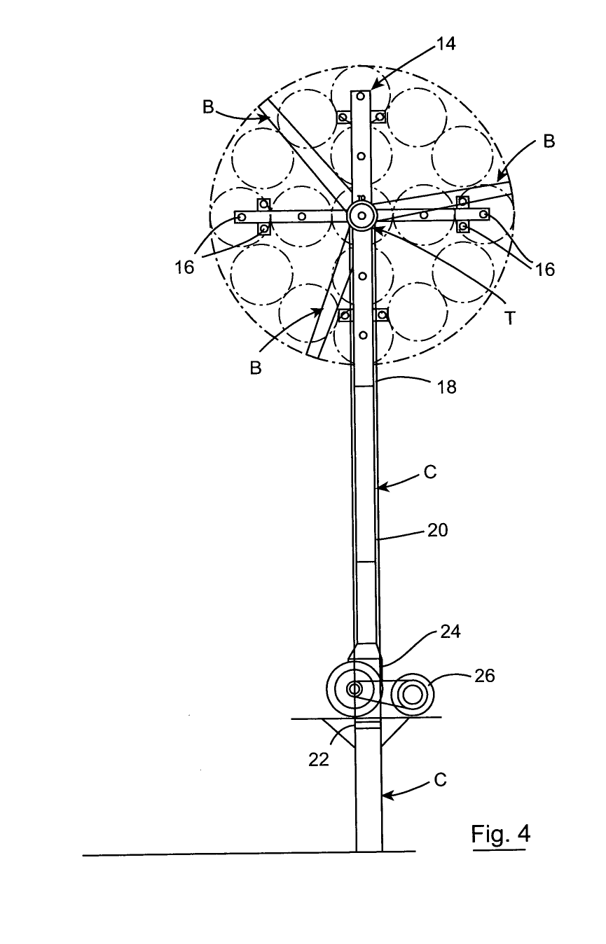

Thus, as the wind reaches the second array 14, the turbulence has been significantly reduced, while its velocity has been increased. The second array 14 of nozzles 16 again issue jets of high velocity air which serve to further reduce the turbulence of the wind, but are intended primarily to accelerate the wind velocity in order to achieve a desired or targeted coverage across the sweep of the blades B and thus maximise the power, whether electrical or otherwise, obtainable from the turbine T. The sweep of the blades B, with the coverage from the nozzles 16 superimposed therein, is illustrated in FIG. 4. Again, the nozzles 16 of the second array 14 may be individually adjustable both for direction, pressure and velocity, in order to optimise the conditioning of the wind flowing therepast.

As mentioned above, on flowing past the blades B the wind turbulence, velocity and direction should be such as to gain the desired coverage on the sweep area of the turbine T as illustrated in FIG. 4. Thus, at installation to a turbine T the enhancement system 10 is preferably calibrated in order to ensure, as far as possible, a designed velocity profile across a targeted sweep area of the blades B.

In order to maximise the effect of the first and second arrays 12, 14, it is necessary to position these a relatively short distance upstream of the blades B. In the preferred embodiment illustrated the first array 12 is positioned a first distance from the blades B while the second array 14 is positioned a second distance from the blades B, although it will of course be appreciated that this distance may be varied as required in order to maximise the performance of the enhancement system 10.

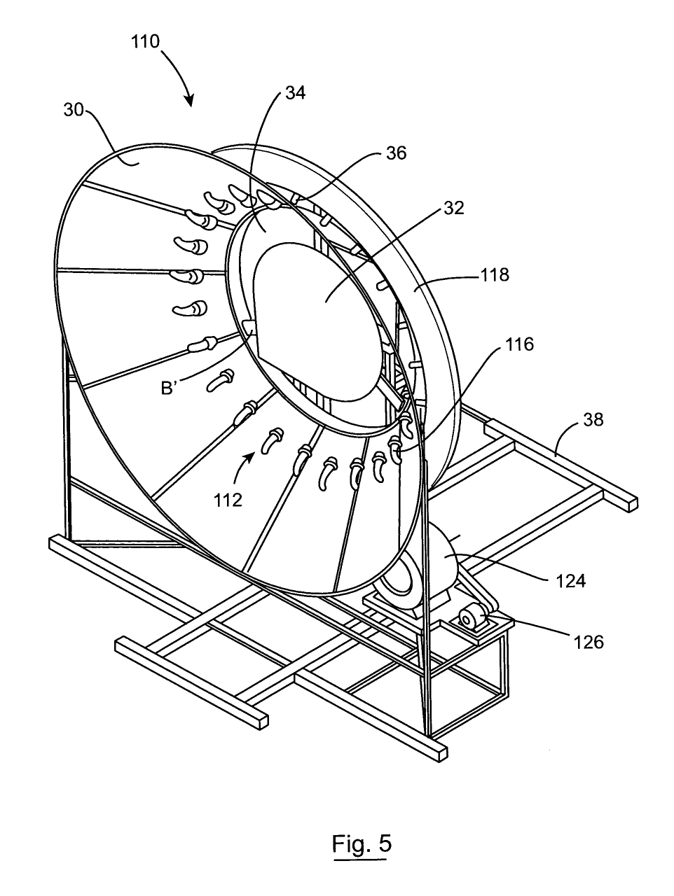

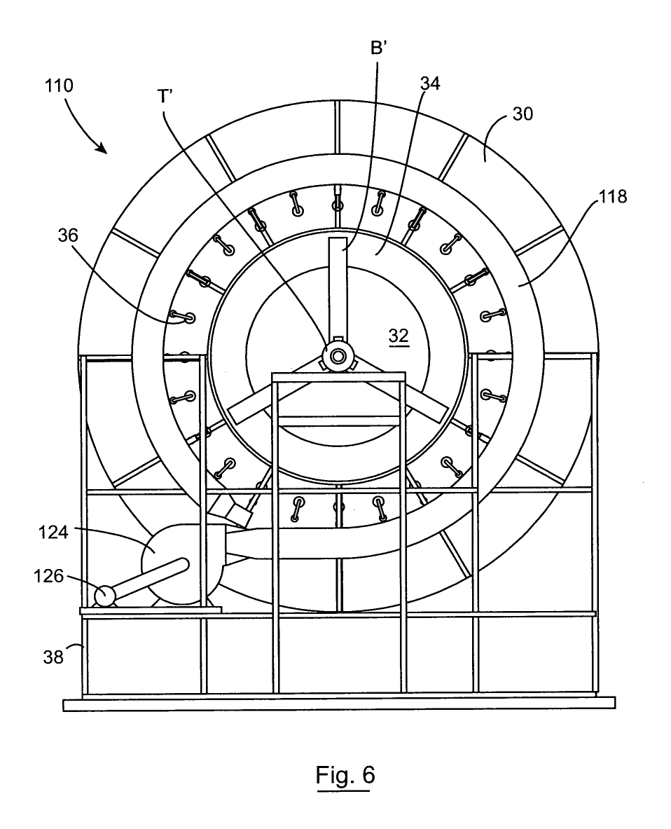

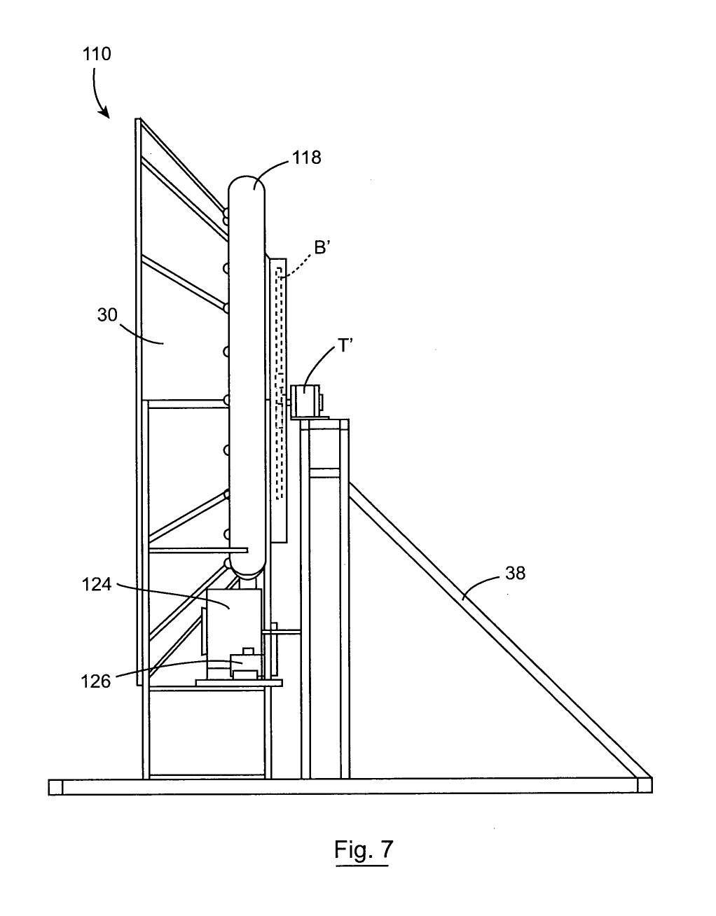

Referring now to FIGS. 5 to 7 of the accompanying drawings, there is illustrated a second embodiment of a turbine enhancement system according to the present invention, generally indicated as 110, which is again adapted to be retrofitted to, or formed integrally with, a wind turbine T′. In this second embodiment like components have been accorded like reference numerals, and unless otherwise stated, perform a like function.

The system 110 comprises an injector in the form of a circular array 112 of nozzles 116, which are positioned in use, upstream of blades B′ of the turbine T′. The nozzles 116 are adapted, as will be described in detail hereinafter, to issue jets of high velocity air towards the blades B′, at a velocity and in a direction which conditions the airflow by reducing the turbulence, controlling the pressure, and increasing the velocity of the prevailing wind blowing past the blades B′. It will be appreciated that the number and design of nozzles 116 may be varied as required, in particular to suit the diameter of the blades B′. Indeed, the nozzles 116 could be replaced with any other means capable of injecting air into the wind upstream of the turbine T′. The nozzles 116 could also inject a fluid or gas other than air, although this is less desirable.

The main difference between this second embodiment of the invention and the first embodiment described above is the provision of a first guide in the form of a truncated conical cowl 30 which in use is positioned in close proximity to, and upstream of, the blades B′ of the turbine T′. The system 110 further comprises a second guide in the form of a cone 32 which sits concentrically within the cowl 30 as illustrated, and again almost abutting the blades B′ of the turbine T′. The cowl 30 and cone 32 are positioned to be upstream of the blades B′ with respect to the direction in which the wind is blowing. The cowl 30 and cone 32 together define an annular channel 34 therebetween, which channel 34 itself defines an outlet for air flowing into the cowl 30, and which channel 34 is therefore aligned, in use, directly in front of the sweep area of the blades B′. The dimensions and relative position of the channel 34 may be varied in order to cover a greater or lesser amount of the sweep area of the blades B′. To this end it is well know that there is a particular portion of the length of each blade of a wind turbine which is responsible for generating the majority of the power available. The annular channel 34 is therefore preferably arranged and dimensioned to overly this portion of the sweep area of the blades B′.

The cowl 30 therefore serves to capture a larger amount of the upstream airflow and channel it onto the blades B′ in order to extract a greater amount of power from the turbine T′. The cowl 30 may also serves to focus the upstream airflow onto the most efficient area of the blades B′ for the purposes of power generation. In addition the cowl 30 acts as a support for the circular array 112 of nozzles 116, which in the embodiment illustrated are mounted to the interior surface of the cowl 30, and which preferably direct their jets of high pressure air in a direction substantially parallel to the wall of the cowl 30 and through the annular channel 34 onto the blades B′. The nozzles 116 perform the same function as the nozzles 16 described in the first embodiment above, namely conditioning the air by reducing the turbulence and/or increasing the velocity of the airflow. The nozzles 116 are also preferably oriented, and of a sufficient number, such that the jets of air from adjacent nozzles 116 overlap slightly within the annular channel 34 in order to ensure adequate conditioning of substantially all of the air flowing through the channel 34.

Feeding the nozzles 116 is supply means comprising an annular section of ducting 118 which in this second embodiment is mounted concentrically and outwardly of the cowl 30, and is fed from a suitable fan 124 driven by a motor 126 or any other suitable means. The ducting 118 is closed at the end distal the fan 124 and is tapped at a number of positions along the length thereof by an elbow connector 36 which itself passes through a correspondingly positioned aperture (not shown) in the cowl 30, with a nozzle 116 then being mounted to the end of each of the elbow sections 36. The fan 124 and motor 126 can therefore supply pressurised air via the ducting 118 to the circular array of nozzles 116. It will be appreciated that the arrangement shown may be varied, in particular the layout of the ducting 118, while still achieving the above-mentioned functionality.

The dimensions and/or orientation of both the cowl 30 and the cone 32 may be variable in order to vary the effect the cowl 30 and cone 32 have on the airflow being directed onto the blades B′, and this may be manually or automatically implemented. For example, the degree of taper of the cowl 30 may be varied, the dimensions of the open end of the cowl 30 immediately adjacent the turbine T′ may be varied, and similarly the dimensions and/or orientation of the cone 32 may be varied and indeed its position within the cowl 30 may be varied. This may then enable the dimensions of the annular channel 34 to be varied, for example to better suit current wind conditions or provide better coverage of the optimum portion of the sweep area of the blades B′ In the embodiment illustrated the cowl 30 and cone 32 are mounted to a frame 38, although the method used to mount the cowl 30 and/or cone 32 may be varied as required. For example, the cone 32 could be mounted to the hub of the turbine T′ in order to rotate therewith. The cowl 32 could be mounted to the support column (not shown) of a wind turbine, or by any other suitable means.

It will also be appreciated that an additional or second array (not shown) of nozzles may be provided about the cowl 32, for example upstream of the array 112 or diametrically inwardly of the array 112. An array of nozzles (not shown) could also be mounted to the outer surface of the cone 32.

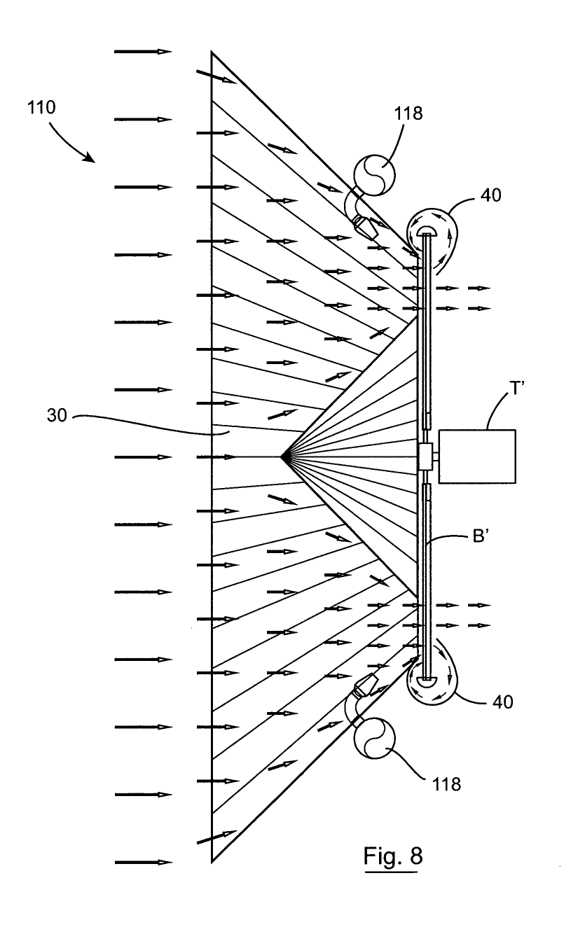

Referring to FIG. 8 there is illustrated the system 110 comprising an additional and optional feature in the form of a recirculation baffle 40 which is positioned such as to circumscribe the outer tips of the blades B′, and is annular in shape, such as to effectively encase the tips of the blades B′. The baffle 40 serves to capture a portion of the wind which has passed through the blades B′ via the cowl 30, and to re-circulate it back around to the front of the blades B′ for a further pass through the blades B′. The baffle 40 extends from the rear or downstream side of the blades B′ and curves back around the outer edge of the sweep area of the blades before terminating adjacent the exterior surface of the cowl 30, directly in front or upstream of the blades B′. Thus the baffle 40 will not re-circulate the air back into the cowl 30 but will rather re-circulate the air onto the outermost portion of the blades which lies outside the coverage of the cowl 30. The baffle 40 may be mounted to the cowl, or may be secured in place by any other suitable means.

By using the enhancement system 10; 110 of the present invention, the wind turbine T; T′ increase energy production. Although in the embodiments illustrated, the motor 26; 126 is drawing energy from the turbine T; T′, this is more than offset by the increase in performance generated by the enhancement system 10; 110.

It should also be noted that as the turbine T; T′ is producing more energy per m² of the sweep area, the blades B; B′ can be reduced in size, and the height at which the blades B; B′ are positioned, can also be reduced, thereby reducing the initial cost of the turbine T and increasing the number of sites at which wind turbines can be deployed. Generally wind turbines require a site at a significant elevation and having consistently high wind speeds, thus significantly limited the number of suitable locations. The enhancement system 10; 110 of the present invention will allow wind turbines to be located at a large number of sites which would otherwise be considered unsuitable.

In both of the above embodiments the enhancement system could be mounted at the turbine, for example, in the locality of the exhaust of a relatively large scale ventilation system (not shown) for example as used in a underground car park or large office building or the like. Thus rather than wasting the energy in the exhausted air, it could be used to power a turbine, with the aid of the enhancement system 10; 110, in order to generate power.

The system 10; 110 of the present invention therefore provides a simply yet highly affective means and method of improving the performance of a wind turbine. The system 10; 110 involves very few moving parts, which is beneficial for reliability while also minimizing cost. The various components of the system 10; 110 may be manufactured from any suitable material, but preferably from a lightweight material such as plastic, a composite, or other material.

1. A turbine enhancement system comprising an injector for injecting a first fluid into an upstream second fluid flow of a turbine in a manner which conditions the second fluid flowing past blades of the turbine.

2. The turbine enhancement system according to claim 1 in which the injector is adapted to issue at least one jet of the first fluid therefrom.

3. The turbine enhancement system according to claim 1 comprising means for supplying the first fluid to the injector.

4. The turbine enhancement system according to claim 3 in which the supply means are arranged to supply the first fluid to the injector from a location remote from the upstream second fluid flow of the turbine.

5. The turbine enhancement system according to claim 3 in which the injector comprises an inlet with which the supply means is in fluid communication, and an outlet from which the first fluid is injected into the upstream second fluid flow.

6. The turbine enhancement system according to claim 1 in which the injector is shaped and dimensioned to accelerate the first fluid flowing therethrough.

7. The turbine enhancement system according to claim 1 in which the injector is adapted to provide a designed velocity profile across a targeted sweep area of the blades of the turbine.

8. The turbine enhancement system according to claim 1 in which the injector comprises at least one array of nozzles.

9. The turbine enhancement system according to claim 1 in which the injector comprises a first array of nozzles locatable a first distance from the turbine, and a second array of nozzles locatable a second distance from the turbine.

10. The turbine enhancement system according to claim 1 in which the injector is adapted to condition the second fluid flow over a targeted sweep area of the blades.

11. The turbine enhancement system according to claim 8 in which at least some of the nozzles comprise air induction nozzles.

12. The turbine enhancement system according to claim 3 in which the supply means comprises a fan and motor.

13. The turbine enhancement system according to claim 12 in which the supply means comprises ducting extending from the fan to the injector.

14. The turbine enhancement system according to claim 13 in which the ducting comprises a support for the injector.

15. The turbine enhancement system according to claim 1 comprising a coupling adapted to enable the injector to be mounted to a turbine.

16. The turbine enhancement system according to claim 15 in which the coupling is adapted to enable the injector to undergo displacement relative to the turbine in a manner which allows the injector to track a set of blades of the turbine.

17. The turbine enhancement system according to claim 3 in which the supply means are adapted to be powered by the turbine.

18. The turbine enhancement system according to claim 1 comprising a wind turbine with which the injector is in operative association.

19. The turbine enhancement system according to claim 1 comprising a first guide which is shaped and dimensioned to funnel the upstream second fluid flow towards the turbine, the injector being arranged to inject the first fluid into the upstream second fluid flow within the first guide.

20. The turbine enhancement system according to claim 19 comprising a second guide which cooperates with the first guide to focus the upstream second fluid flow onto a selected portion of the sweep area of the blades of the turbine.

21. The turbine enhancement system according to claim 19 in which the injector comprises an array of nozzles disposed about the first and/or second guide.

22. The turbine enhancement system according to claim 19 in which the dimensions of the first and/or second guide may be varied.

23. The turbine enhancement system according to claim 19 in which the first guide comprises a truncated conical cowl.

24. The turbine enhancement system according to claim 23 in which the second guide comprises a cone mounted concentrically within the cowl such as to define a substantially annular channel between the cowl and the cone.

25. The turbine enhancement system according to claim 19 comprising means for re-circulating at least a portion of the second fluid exiting a downstream side of the blades back to the upstream side of the blades.

26. The turbine enhancement system according to claim 3 in which the supply means utilize mechanical induction to supply the first fluid to the injector.

27. A method for enhancing the performance of a wind turbine, the method comprising injecting a first fluid into an upstream second fluid flow of the turbine in a manner which conditions the second fluid flowing past blades of the turbine.

28. The method according to claim 27 comprising the step of issuing at least one jet of the first fluid into the upstream second fluid flow.

29. The method according to claim 27 comprising the step of supplying the first fluid for injection from a location remote from the upstream second fluid flow of the turbine.

30. The method according to claim 27 comprising the step of accelerating the first fluid flowing during injection into the upstream second fluid flow.

31. The method according to claim 27 comprising injecting the first fluid into the upstream second fluid flow from a first location.

32. The method according to claim 31 comprising injecting the first fluid into the second fluid flow from a second location remote from the first location.

33. The method according to claim 27 comprising the step of extracting power from the turbine in order to affect the supply of the first fluid for injection.
